(19) United States
(12) Patent Application Publication
(10) Pub. No.: US 2008/0230559 A1
(43) Pub. Date: Sep. 25, 2008

(54) Aerosol Container with Actuator Secured to Valve Stem

(76) Inventor: Peter Nardone, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/569,627

(22) PCT Filed: May 26, 2005
(86) PCT No.: PCT/AU05/00739

§ 371 Date: Nov. 27, 2006

(30) Foreign Application Priority Data
May 26, 2004 (AU) 2004902793

(51) Int. Cl. B67B 5/00; B67D 5/06; B65D 83/00

(52) U.S. Cl. 222/153.05; 222/402.1; 222/153.1; 222/182; 222/153.06

(57) ABSTRACT

A security seal for an aerosol container (12), which has an actuator (16) in communication with a valve (14). Means are provided such as adhesive (24), contact cement or a weld to deter removal of the actuator (16) from the valve system (14). The valve system (14) and actuator (16) are made of compatible materials so they may be joined by laser or sonic welding, or by solvent cement. Optionally, a collar (26) has a first ledge (28) that locks under rim (18) and has a second ledge (30) that engages a base portion (27) of the actuator and prevents its removal, except by breaking the collar. The security seal can include means such as a cap (34) which is joined to the collar (26) by a frangible connection (38), to provide a tamper indication of whether the actuator (16) has been accessed.

### TECHNICAL FIELD

This invention relates to improvements in aerosol container security. The invention has wide application, as will be appreciated by the disclosure below.

### BACKGROUND TO THE INVENTION

The invention deals with aerosol containers of the well-known type in which there is a spray mechanism for dispensing a substance contained in the container under pressure. Dispensing takes place via manual depression of a actuator which communicates with the contents of the container via a valve. The word “aerosol container” as used herein is intended to encompass all appropriate types of container, whether they are made of iron, aluminium or other materials.

The invention is concerned with many different types of aerosol container. Some of these will be mentioned.

The most commonly-used type of aerosol container has a male valve, with a valve stem projecting from the top of the aerosol container. The actuator is mounted on the valve stem.

Some aerosol containers have a female valve. This does not have a valve stem, but rather includes a valve seat.

Another type of aerosol container has a bag welded to the aerosol valve. The product to be dispensed is in the bag and the propellant is contained a sleeve outside the bag.

Conventional aerosol containers usually have a mounting cup, regardless of the type of valve. Small, button-type actuators do not contact the mounting cup but are usually attached to the valve stem of a male valve. Another type of actuator is a full-cup actuator, which fills the mounting cup, but stays within the rim or perimeter of the mounting cup. A third type of actuator includes a collar, which attaches to the rim or perimeter of the mounting cup.

In some cases, aerosol containers are provided with overcaps. An overcap is designed to fit over the actuator and to protect it from accidental discharge.

Aerosol cans with male valves may have a different type of actuator, known as a spraycap. These fit directly onto the aerosol container and usually have an insert which is manipulated by the user to depress the valve.

There have been many inventions made aimed at providing an indication as to whether an aerosol container has been subject to tampering. The need for this type of invention has arisen for many reasons, as discussed below. However, the present invention has been prompted primarily by the desire to provide aerosol containers which are not refillable via the valve stem and then reused, and in particular to ensure that contents cannot be contaminated or substituted by other, perhaps dangerous, contents.

Conventional aerosol containers may have their contents contaminated or replaced. Conventional aerosol containers usually have some type of dispensing actuator mounted on a valve stem or communicating with a valve seat. Depression of the dispensing actuator causes opening of the valve and allows the contents of the container to be dispensed. The dispensing actuator in a conventional aerosol container may be pulled off and a contaminant can be introduced into the aerosol container through the valve. It is also possible for the contents of a conventional aerosol container to be expelled fully or partially and for the container to be refilled with different contents.

This gives rise to concerns relating to terrorism and, in particular, aircraft safety. If the actuator of an aerosol container can be removed, the contents of the aerosol container can be replaced. It is possible to replace the contents with a substance capable of causing harm, for instance, a poison, capsicum spray, mace, tear gas or other material, which could be used in a terrorist attack. It would be desirable to provide an aerosol container with means which would prevent the removal of the actuator, or which would prevent the container from being reused if the actuator could be removed.

There are also other situations in which it is desirable that the actuator of an aerosol container cannot be removed. An example is of the use of aerosol cans for graffiti. A graffiti artist will normally desire to exchange the standard actuator on an aerosol paint can with a more tailored actuator for producing graffiti. It would be desirable to be able to provide aerosol paint cans with means for preventing removal of the standard actuator, and thus deter the use of those aerosol paint cans for graffiti.

Reference was made above to prior art aimed at providing an indication as to whether an aerosol container has been subject to tampering. Some of the reasons for the need for this type of invention are discussed below.

When a consumer is purchasing an aerosol container, the purchaser prefers to know whether there has been any tampering. First, the consumer prefers that the aerosol container has not been “tested” by another consumer, because this invariably dispenses some of the contents of the aerosol container. The consumer wishes to be certain that the consumer is obtaining fuill value for the price of the aerosol container. For example, aerosol containers containing hairspray or body spray are relatively expensive. A consumer would prefer to be certain that the contents had not been dispensed before purchase, so that the consumer is not paying a high price for a product containing less of the desired ingredient than indicated on the packaging.

The consumer also wishes to be comfortable that the contents of the aerosol container have not been contaminated. For example in “testing” an aerosol container, it may be possible to introduce bacteria or a virus into the container or around the actuator.

Especially when the aerosol can contains paint, it is desirable that there has been no prior “testing” of the contents. The reason for this is that, unless the aerosol can has been inverted during “testing”, it is likely that the actuator may be blocked by paint residue and consequently the can may not work properly when later purchased.

For all the above reasons, and possibly for other reasons, it is desirable to have some indication that access has been gained to the actuator of an aerosol container. As already stated, there have been many inventions aimed at meeting this need.

There is also a desire to protect the valve stem of an aerosol container. If an aerosol container is dropped, it may occur that the valve stem and actuator break off. This means that the contents of the container can no longer be dispensed, because the actuator cannot be mounted on the valve stem. The aerosol container has had to be discarded in these circumstances.

It is an object of the present invention to provide means capable, at least in some embodiments, of addressing some or all of these concerns and to alleviate some or all of the problems referred to above.

### DISCLOSURE OF THE INVENTION

Accordingly, the invention provides a security seal for an aerosol container having an actuator in communication with a valve, wherein the seal includes means for deterring removal of the actuator from the aerosol container.

The actuator may take the form of a button or small actuator, or of any of the actuators described above.

In the security seal of the invention, the means for deterring removal of the actuator from the container may take any suitable form. In one embodiment, the container has a valve stem and the means includes an adhesive or contact cement, binding the actuator to the valve stem. In another embodiment, the means includes a weld between the actuator and the valve stem. The weld may be effected by any suitable means, including laser or sonic welding. Other means of attachment may also be suitable.

If the container has a valve stem, the actuator may be integral with the valve stem, eg, being formed with it during manufacture.

In another embodiment, the means for deterring removal of the actuator from the container is mechanical. For example, there may be a barb creating an interference to removal of the actuator, the barb adapted to engage the container.

In particular, it is preferred that the means includes a collar centred adapted to engage the actuator and physically prevent removal of the actuator except by breakage of the collar, which itself is secured to the container, for example by locking under a rim of the container. This embodiment is preferred because presence of the collar gives a ready indication that the actuator has not been removed from the container and that therefore there has been no contamination or substitution of the contents of the container.

When the means for deterring removal from the actuator includes a collar, the collar should not impede passage of the contents of the container through the actuator. In practice, this usually means that the collar should sit below any outlet in the actuator.

Aerosol containers generally have an inner rim adjacent to the actuator and an outer rim. The inner rim is usually the same diameter for all aerosol containers. It is this rim which is usually adjacent the actuator. The fact that this rim is the same diameter for virtually all aerosol containers greatly facilitates the application of the security seal of the present invention.

Often, this inner rim is located near the junction between the actuator assembly and the top or shoulder portion of the container, which supports the actuator assembly. The second or outer rim, if it is present, is usually formed at the junction of the sidewall of the container, about its upper periphery. The outer rim has a diameter which varies from manufacturer to manufacturer and which may depend on the size of the container.

Optionally, the security seal of the invention also includes means for indicating whether the actuator has been accessed. The means for indicating whether the actuator has been accessed may take any desirable form, but conveniently includes a cap for the actuator, the cap being secured by means which are irreversibly breached if the cap is removed. Such means is known and includes frangible attachments. Preferably, when the means for deterring removal of the actuator from the container includes the collar described above, the means for indicating whether the actuator has been accessed includes a cap attached to the collar by an area of weakness or by a frangible connection.

If it is desired to have an overcap, for example, which attaches to the outer rim of the container, it is preferred that the overcap is transparent so that the security seal of the invention can be seen without having to remove the overcap. In this way, the integrity of the security seal of the invention may be inspected before purchase.

It will be appreciated that the security seal of the invention in its various embodiments can address some or all of the problems referred to above. In particular, when the security seal of the invention takes the embodiment in which a collar is combined with a cap secured to the collar by frangible means, when the cap has been removed by the consumer after purchase to gain access to the actuator, the collar can still prevent removal of the actuator from the container. Thus the consumer can present the container for inspection at, for example, airport inspection points before boarding. Security personnel will be able to see that the collar is in place and that therefore the integrity of the contents of the container is ensured.

### BRIEF DESCRIPTION OF THE DRAWING

The invention will now be described in connection with certain non-limiting examples, in connection with the accompanying drawings, in which:

FIG. 1 is a side sectional view of a prior art actuator assembly;

FIG. 2 is a view similar to FIG. 1, but showing a first embodiment of deterring means of the security seal of the present invention;

FIG. 3 is a similar view to that of FIG. 2 but shows a second embodiment of the deterring means, being a collar, together with an indicating means;

FIG. 4 shows the assembly of FIG. 3, with the indicating means removed;

FIG. 5 shows the embodiment of FIGS. 3 and 4, after the collar has been removed;

FIG. 6 shows an embodiment of the security seal where the aerosol container has a spray cap; and

FIG. 7 shows the embodiment of FIGS. 3 to 5 with an overcap.

### DETAILED DESCRIPTION OF THE DRAWINGS

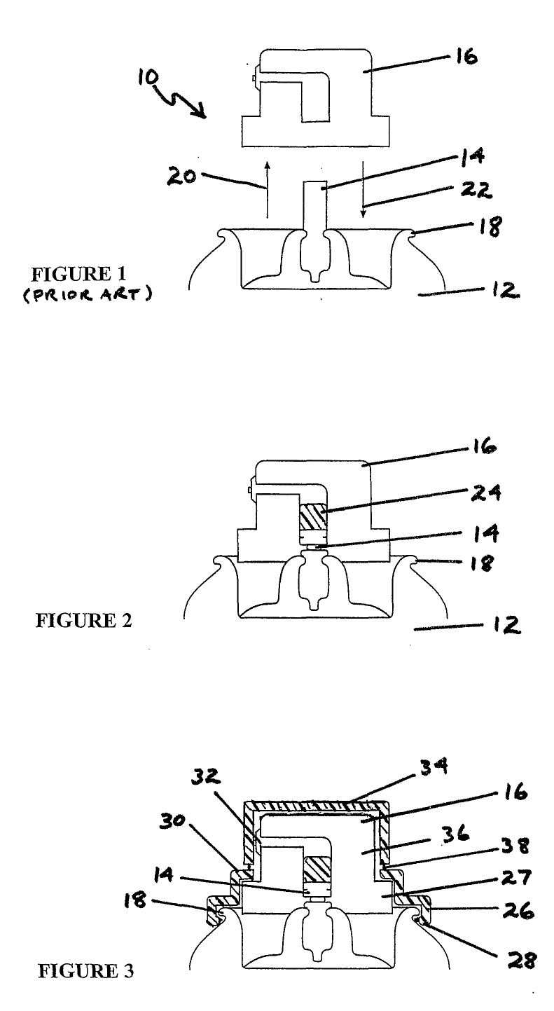

Referring first to FIG. 1, it will be seen that the prior art assembly 10 includes a container 12, valve stem 14, actuator 16 and rim 18. Actuator 16 may be lifted off valve stem 14 by pulling in the direction of arrow 20 and may be replaced by pushing in the direction of arrow 22. Thus, contents of container 12 may be expelled by removing actuator 16 and replaced by other contents. Once actuator 16 is replaced, it is not possible to tell by inspection of container 12 whether there has been any change in the nature or volume of the original contents.

In FIG. 2, actuator 16 is shown fixed to valve stem 14 by contact adhesive 24, conveniently during manufacture after contents have been inserted in container 12.

As an alternative, there may be a mechanical lock between valve stem 14 and actuator 16. As another example, if valve stem 14 and actuator 16 are made of the same or compatible materials, they may be joined by laser or sonic welding, or by solvent cement. In another arrangement, valve stem 14 and actuator 16 may be manufactured in one piece. Other arrangements may be possible, as appropriate in the industry.

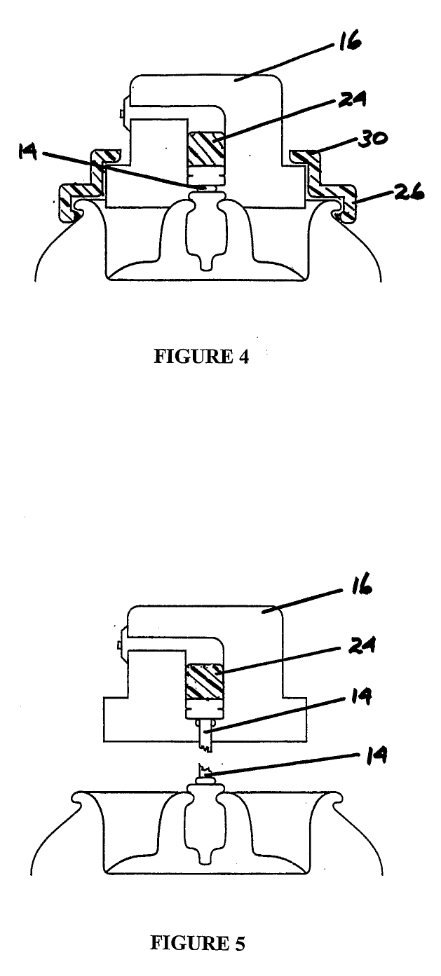

Referring now to FIGS. 3 to 5, collar 26 is shown sited around base 27 of actuator 16. Collar 26 includes ledge 28, which locks under rim 18, and ledge 30 which captures base 27 of actuator 16. Collar 26 prevents actuator 16 from being removed from base 27, unless collar 26 is destroyed. Removal of collar 26 in this way would immediately signal that actuator 16 may have been removed and cause doubt as to the integrity of the contents of container 12.

It will be noted that the siting of collar 26 does not cause any interference with the operation of orifice 32 of actuator 16.

Collar 26 also serves to protect actuator 16 and valve stem 14. If container 12 is dropped, collar 26 is likely to prevent valve stem 14 and/or actuator 16 from breaking away from container 12.

If actuator 16 is inclined to wobble, as occasionally occurs with conventional containers, collar 26 can help to stabilise actuator 16.

FIG. 3 includes an embodiment of the means for indicating whether the actuator has been accessed. In this embodiment, cap 34 covers the upper part 36 of actuator 16 and prevents access to actuator 16. Cap 34 is joined to collar 26 by a frangible connection 38, which can be breached by pushing or twisting cap 34 relatively to collar 26. Frangible connection 38 may take any desirable configuration. Many of these are already known or will be apparent to one skilled in the art. Once the frangible connection 38 has been breached, cap 34 can be removed (and discarded) and actuator 16 accessed. It should not be possible to replace cap 34 on collar 26 to disguise the fact that frangible connection 38 has been breached.

Preferably, collar 26 is labelled “not to be removed” to alert the consumer that actuator 16 is not removable. If collar 26 is broken or tampered with in an attempt to remove actuator 16, it is very likely that valve stem 14 will break as shown in FIG. 5, especially if stem 14 has been weakened for this purpose. This effectively disables the container, trapping the contents in the container and, importantly, preventing its reuse.

A consumer looking at container 12 will be able to tell immediately if actuator 16 has been accessed and can choose to reject container 12 in that event.

A security guard, for example, can also tell by inspection if actuator 16 has been accessed.

Further, a consumer may present a container with cap 34 intact to a retailer for a refund, if desired.

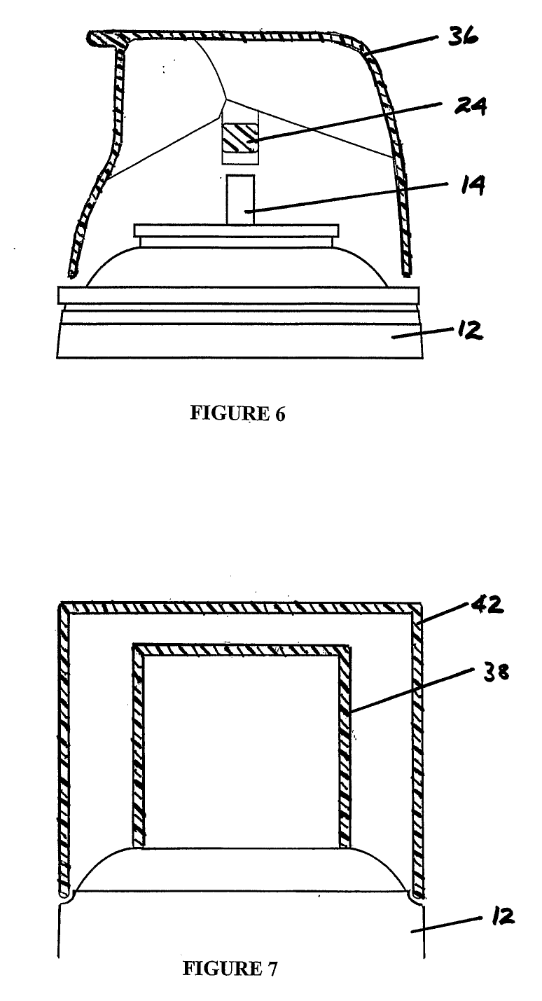

The assembly in FIG. 6 is similar to that in FIG. 2, except that actuator 16 is replaced by spray cap 36, fixed to valve stem 14 by weld 24.

FIG. 7 shows the embodiment of FIGS. 3 to 5, with collar 26 and cap 34 shown schematically at 38, and includes overcap 42. Preferably, overcap 42 is transparent so as to reveal the security seal of the invention. In this way, a consumer may inspect the integrity of the security seal through the overcap 42. It will be appreciated that overcap 42 may take any suitable configuration.

### INDUSTRIAL APPLICABILITY

It will be appreciated that the security seal of the invention has wide application industrially and in particular can prevent aerosol containers from being refilled.

1. A security seal for an aerosol container having an actuator in communication with a valve via a valve stem, wherein the seal includes:
means for deterring removal of the actuator from the aerosol container without preventing opening of the valve through actuation of the actuator, the means including: an adhesive, contact cement or a weld binding of the actuator to the valve stem, or the actuator being integral with the valve stem, or a barb on the actuator, the barb adapted to engage the container and create interference to removal of the actuator from the container.

2. The security seal of claim 1, wherein the means includes the weld and the weld is effected by laser or sonic welding.

3. The security seal of claim 1, wherein the valve stem has a weakened area.

4. The security seal of claim 1, which includes a collar adapted to engage the actuator and prevent removal of the actuator except by breakage of the collar, the collar being secured by the container.

5. The security seal of claim 4, wherein the collar is secured to the container by locking under a rim of the container.

6. The security seal of claim 1, which includes means of indicating whether the actuator has been accessed.

7. The security seal of claim 6, wherein the indicating means includes a cap for the actuator, the cap adapted to be secured to the container by a frangible connection.

8. The security seal of claim 4, which includes a cap for the actuator, the cap adapted to be secured to the collar by a frangible connection.

9. The security seal of claim 1, which includes an overcap.

10. (canceled)
